(19) United States
(12) Patent Application Publication
(10) Pub. No.: US 2025/0172229 A1
(43) Pub. Date: May 29, 2025

(54) DEVICE FOR INTERNAL PLUGGING OF FLEXIBLE PIPELINES AND METHOD OF INSTALLING THE DEVICE

(71) Applicant: PETRÓLEO BRASILEIRO S.A. – PETROBRAS, Rio de Janeiro (BR)

(72) Inventors: Pedro Paulo BEZERRA DA CUNHA CASTRO, Macaé (BR); Douglas Oliveira CORREA DE SOUZA, Macaé (BR); Andre Luiz BEVILAQUA SANTANA, Macaé (BR)

(21) Appl. No.: 18/955,751

(22) Filed: Nov. 21, 2024

(30) Foreign Application Priority Data
Nov. 28, 2023 (BR) 1020230248543

(51) Int. Cl. F16L 55/11

(52) U.S. Cl. CPC F16L 55/1108

(57) ABSTRACT

Disclosed herein are equipment and devices for plugging subsea pipelines, including a device for internal plugging of flexible pipelines. The device may include: a central threaded rod; a first conical mandrel and a second conical mandrel; an upper guide rod and a lower guide rod; a first sealing element and a second sealing element; an external clamp; and a central drive nut; wherein the clamp has a sealing portion having a tab that fits into an upper recess of the clamp and into a lower recess of the clamp. Also disclosed is a method of installing a device for internal plugging of pipelines, including flexible pipelines, wherein the method includes: inserting the device into an open end of a subsea pipeline; locking the device in the pipeline; and actuating the rod of the device by tightening the central drive nut to plug the pipeline.

### FIELD

The embodiments related to the area of equipment and devices for plugging subsea pipelines, and, more particularly, to a device handled by a remotely operated vehicle (ROV) for internal plugging of subsea flexible pipelines cut due to failures and that need to be collected in contingency scenarios.

### BACKGROUND

Subsea pipelines are essential components in the development and production of offshore resources in the oil and gas industry. As offshore oil and gas fields reach the end of their production life, it is necessary to consider the decommissioning strategy for these subsea pipelines, which often involves a process of collecting the used pipeline.

Typically, in a subsea flexible pipeline recovery operation, one end of the pipeline is first plugged with a blind flange, while the pipeline itself is retracted from the other end using a traction head.

However, for pipelines that do not have a connector at one end, due to a rupture failure, for example, conventional plugging ends up being unfeasible due to the absence of a flange.

In addition, the inner wall of the flexible pipeline is formed by an interlocked steel profile in a helical shape, which generates an irregular surface that is difficult to seal.

Thus, there is a need in the state of the art for the development of a device to plug/seal the cut end of a ruptured subsea flexible pipeline when it is necessary to recover the pipeline, without the fluid inside the pipeline escaping to the external environment. Furthermore, there is also a need for the plugging device to be handled entirely by an ROV, for safety reasons and/or impossibility of human access due to the water depth (LDA), in a diverless operation.

CN 219588416 U relates to a small diameter pressure plug comprising a connecting rod, a blind hub, a clamp, a sealing ring and a tube hub, the rod being provided in a cylindrical configuration and having a through hole axially therethrough, the rod being provided with external threads on both outer sides of the ends, respectively, the blind hub and the tube hub being provided with a hollow configuration and being fixedly connected by a clamp on the outer sides of the opposite connecting ends. The stem corresponds to a hollow structure extending through the blind hub and the tube hub and is fixedly secured on both sides of the blind hub by a first and a second lock nut on both external threads respectively, and the sealing ring is nested on the stem in the tube hub between the first and the blind hub.

CN 219588416 U has an application for plugging rigid pipelines, however, with a smooth internal wall, instead of a pipeline with an internal wall formed by helical grooves, typical of flexible pipelines. In addition, the device in said document discloses the use of a blind flange to assist in the plugging process, which shows that the clamp used by this device is for use on an end already prepared for its use. This type of solution would therefore not meet the same scenario as the present invention, that is, plugging a flexible duct, which has an internal wall formed by a structure with helical grooves, being a type of geometry that is more complex and challenging to perform an effective seal, and which has undergone a cut at its end.

CN 112628519 B discloses a high-pressure self-tightening plug for pipelines and its application. This document belongs to the technical field of sealing/plugging of industrial pipelines, wherein said high-pressure self-tightening plug for pipelines comprises a sealing device for inserting and sealing a pipeline along one end of the pipeline and a locking device installed outside the pipeline, said locking device locking said sealing device and the pipeline. The plug of document CN 112628519 B does not require welding when installed, the sealing is convenient, the sealing structure can be formed at least three times, ensuring the reliability of the seal, and can be used for sealing flexible composite pipelines.

According to the description of the installation steps of the device in CN 112628519 B, the following is done: I—separately inserting a rod (1) into the pipe; II—individually jacketing the seals (2); III—attaching a pipeline end sleeve (3) onto the pipe; IV—jacketing a compression sleeve/tip (4) on the outside of the pipe; V—to energize the external compression of the tip (5), it is necessary to turn the sleeve (3); VI—to energize the seals (2), a nut is placed on the end of the rod (1) and tightened. It is noted, therefore, that for installation of the aforementioned device in the pipeline, especially from steps II to V, the device in document CN 112628519 B does not provide facilities for installation by ROV, for example, handles, so that this solution demonstrates an impossibility of installing the device by means of ROV. The installation would need to be done manually. Therefore, the solution presented in this document does not meet the need related to the plugging of subsea flexible pipelines in water depths where intervention by human diving is not possible.

CN 114526396 A relates to the technical field of auxiliary devices for offshore oil and gas fields, in particular to a device for plugging fractures in oil pipelines. According to the technical scheme, a spiral, a sealing rubber cylinder and a buffer shell are arranged on one side of a directional shell, the center of the spiral is engaged with a protruding gear through an internal gear, the protruding gear is connected with a transmission shaft through a flat key, the outer side of the spiral is connected with a clamping jaw in a combined mode through flat threads, and the end of the clamping jaw contacts the inner wall of the sealing rubber cylinder. A buffer shell is arranged on the outer side of the sealing rubber cylinder, and a clamping jaw rail is arranged on the inner wall of the buffer shell and combined with the clamping jaw to allow the clamping jaw to move in the radial direction to drive the sealing rubber cylinder to contract or expand.

CN 114526396 A, however, does not disclose the use of a clamp or any other type of solution to ensure the anchoring of the plug in the pipeline. Without some type of anchoring, the plug tends to be “expelled” from the pipeline due to the difference in internal and external pressure. Furthermore, document CN 114526396 A does not suggest the seal being able to adapt to the irregular surface of the internal surface of a flexible pipeline.

Furthermore, document CN 216479600 U discloses a double-layer subsea pipeline plugging device comprising a plugging assembly, a plugging clamp and a plugging cap, wherein the plugging assembly is used to plug a pipeline opening of a double-layer subsea pipeline, the plugging clamp is firmly held on the periphery of the double-layer subsea pipeline, and the plugging cap is combined with the plugging clamp. The plugging cap covers the end face of the double-layer subsea pipeline and is connected with the plugging clamp, and the plugging assembly is sealed at a pipeline opening of the double-layer subsea pipeline. According to the double-layer subsea pipeline plugging device, the plugging assembly, clamp and cover are combined. The pipeline opening of the double-layer subsea pipeline is plugged, and the double-layer subsea pipeline plugging device is suitable for plugging the pipeline opening of the cut double-layer subsea pipeline, so that the plugging of a temporarily discarded subsea pipeline is completed and the residual oil in the double-layer subsea pipeline is prevented from leaking and overflowing.

However, the device of the document CN 216479600 U shows a solution for plugging a double rigid pipeline, similar to the pipeline-in-pipeline concept (one rigid pipeline inside another, with an annular space between them), with a smooth inner wall. Furthermore, the sealing method used in this document consists of two sealing pieces acting when compressed on the longitudinal and transverse faces of the end of the pipe, which also demonstrates a scenario different from that intended for use in flexible pipelines.

Finally, U.S. Pat. No. 9,556,997 B2 discloses a large diameter, low pressure plug that can be used to seal a subsea pipe. The large diameter, low pressure plug comprises a nose, two or more counter-rotating rings and one or more seals. Other disclosed embodiments for the plug have additional variable structure. The large diameter, low pressure plug is inserted into the inner ring of a tubular element and a sealing action created by the rotation of the counter-rotating rings to create axial compression, in its turn causing radial expansion in the seal against the inner ring of the tubular element, sealing the tubular element.

However, the aforementioned document U.S. Pat. No. 9,556,997 B2 shows a device that appears to be a solution for plugging rigid pipelines with smooth internal walls. As in document CN 114526396 A, this device also does not appear to have a clamp or other type of anchoring on the external cover, making it difficult to use in flexible pipelines with walls with helical grooves.

As evidenced by the solutions presented in the state of the art, therefore, there is a lack of development of a device for plugging flexible pipelines, which is designed to overcome the challenge of sealing an irregular internal surface, and which is capable of ensuring the anchoring of the plug, without requiring stops or other type of prior preparation of the end to be sealed, therefore, it can be used in underwater pipeline recovery processes in scenarios of pipeline contingencies with a cut end.

### SUMMARY

The present embodiments relate to the area of equipment and devices for plugging subsea pipelines, and, more particularly, to a device handled by a remotely operated vehicle (ROV) for internal plugging of subsea flexible pipelines cut due to failures and that need to be recovered in contingency scenarios.

In general, the embodiments described herein include the development of a device capable of promoting low-pressure plugging using a double sealing system inside the pipeline, combined with a clamp supporting the external cover of the pipeline.

The developed device comprises a gantry for sealing testing, and a relief valve to maintain equalization between internal and external pressure during recovery.

The device offers a faster and simpler solution for plugging cut pipelines, as it only requires insertion into the cut pipeline, tightening the external clamp, and finally actuating the central screw to energize the sealing elements. According to this embodiment, it is possible to collect a ruptured pipeline so that the fluid inside it does not escape to the external environment.

The device described herein represents a solution that may be useful in contingency scenarios with a ruptured pipeline, where a risk analysis indicates the need to plug the cut end before collecting the pipeline.

Another scenario where the solution developed by the embodiments will be useful is for collecting old pipelines in mature fields, whether for decommissioning or reuse. In mature production fields, it is common to have pipeline crossings, caused by newer interconnections overlapping older ones, and when the time comes to decommission or collect a used pipeline, often the only option is to cut the pipeline that is underneath the crossing.

If the pipeline to be cut, for some reason, cannot be guaranteed to be clean, and a risk analysis indicates the need for plugging, the device described herein offers a faster, more effective and simpler solution for plugging cut pipelines, as it only requires insertion into the cut pipe, torquing the external clamp, and finally actuating the central screw to energize the sealing elements.

It is worth noting that the device described in the embodiments can be used by an ROV, without the need for divers (diverless operation). Other techniques under development/application for plugging, for example, the grout boot (cement plug), are more complex and time-consuming to operate, as they require fine control of the cement mixture, pumping a significant amount of the material into the flexible pipe, and waiting for it to cure.

Thus, the embodiments described herein aim to solve the problems mentioned above and achieve the advantages mentioned and apparent by providing, in one embodiment, a device for internal plugging of flexible pipelines, comprising: a central threaded rod; a first conical mandrel and a second conical mandrel; an upper guide rod and a lower guide rod; a first sealing element and a second sealing element; a split external clamp; and a central drive nut; wherein the clamp has a sealing portion having a tab that fits into an upper recess of the clamp and into a lower recess of the clamp.

Additionally, the embodiments also provide, in one embodiment, a method of installing a device for internal plugging of flexible pipelines, wherein the method comprises: inserting the device into an open end, which may be a cut end or not, of a subsea pipeline; locking the device into the pipeline; and actuating the rod of the device by tightening the central drive nut.

### BRIEF DESCRIPTION OF THE FIGURES

The foregoing brief description, as well as the detailed description below, of the preferred embodiments, will be better understood when read in conjunction with the accompanying drawings. For the purpose of illustration, embodiments thereof are shown in the drawings. It should be understood, however, that these embodiments are not limited to the precise arrangements and instruments shown.

Accordingly, various features of the embodiments will be described below with reference to typical embodiments thereof and, also, with reference to the accompanying drawings.

FIG. 1 shows a front perspective view of a device for internal plugging of flexible pipelines, according to an embodiment.

FIG. 2 shows a rear perspective view of a device for internal plugging of flexible pipelines, according to an embodiment.

FIG. 3 shows a rear view of a device for internal plugging of flexible pipelines, according to an embodiment.

FIG. 4 shows a cross-sectional view of section A-A of a device for internal plugging of flexible pipelines, according to an embodiment.

FIG. 5 shows a cross-sectional view of section B-B of a device for internal plugging of flexible pipelines, according to an embodiment.

FIG. 6A shows a front perspective view of a device for internal plugging of flexible pipelines, in the unlocked and de-energized position, inserted into an open end of a duct, according to an embodiment.

FIG. 6B shows a cross-sectional view of a device for internal plugging of flexible pipelines, in the unlocked and de-energized position, inserted into an open end of a pipeline, according to an embodiment.

FIG. 7A shows a front perspective view of a device for internal plugging of flexible pipelines, in the locked and de-energized position, inserted into an open end of a pipeline, according to an embodiment.

FIG. 7B shows a cross-sectional view of a device for internal plugging of flexible pipelines, in the locked and de-energized position, inserted into an open end of a pipeline, according to an embodiment.

FIG. 8A shows a front perspective view of a device for internal plugging of flexible pipelines, in the locked and energized position, inserted into an open end of a pipeline, according to an embodiment.

FIG. 8B shows a cross-sectional view of a device for internal plugging of flexible pipelines, in the locked and energized position, inserted into an open end of a pipeline, according to an embodiment.

### DETAILED DESCRIPTION

In the following, reference is made in detail to the preferred embodiments illustrated in the accompanying drawings. Whenever possible, the same or similar reference numerals will be used throughout the drawings to refer to the same or similar features. It should be noted that the drawings are in simplified form and are not drawn to a precise scale, so that small variations are anticipated.

Initially, it should be noted that the words “duct(s)”, “pipe(s)”, “pipeline (s)”, “riser(s)”, and others, as used throughout this description, should not be interpreted in a specific or limitative manner, but rather in a general manner, and are often used as synonyms to refer to any type of tubular structure for transporting hydrocarbons, as widely used and known in the oil and gas sector.

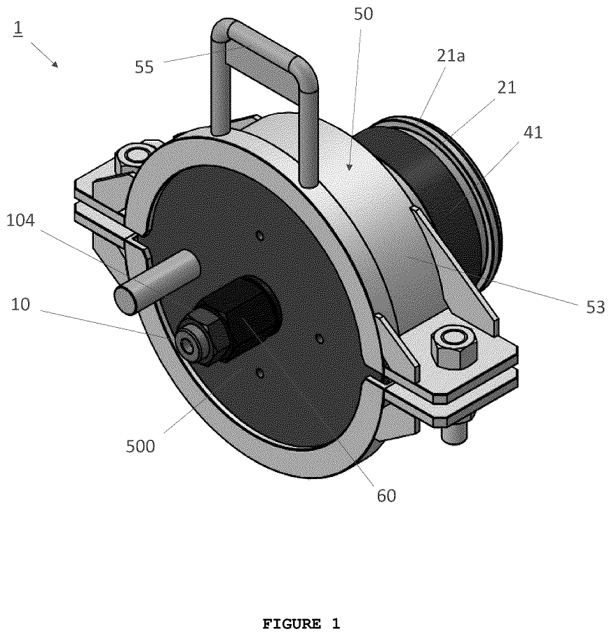

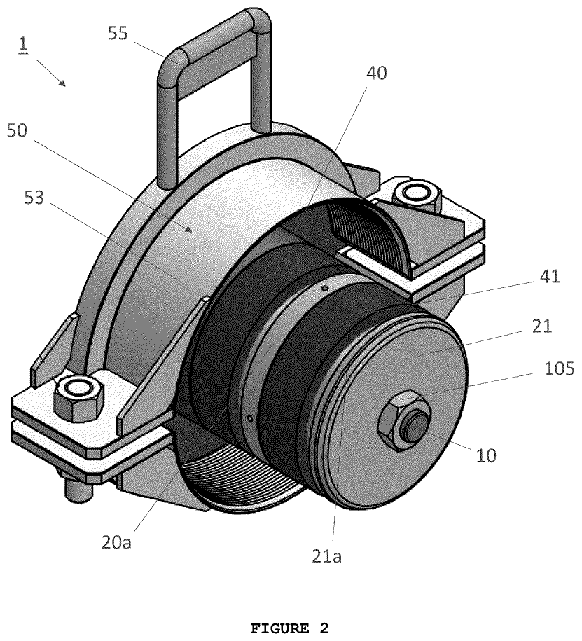

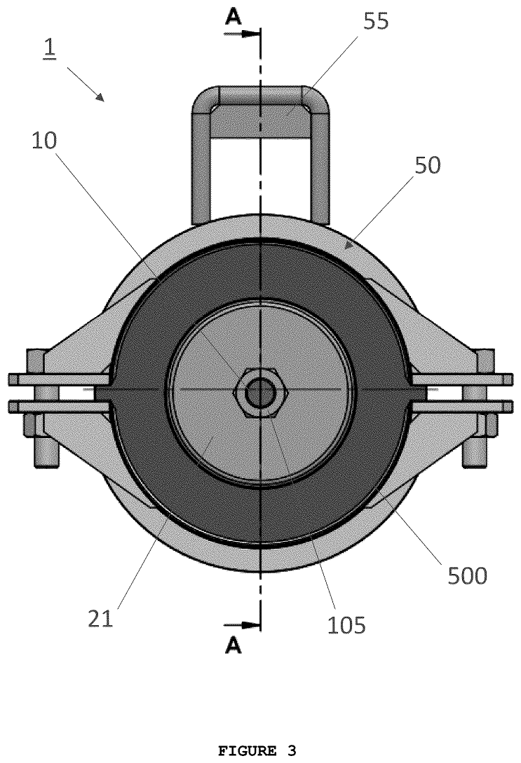

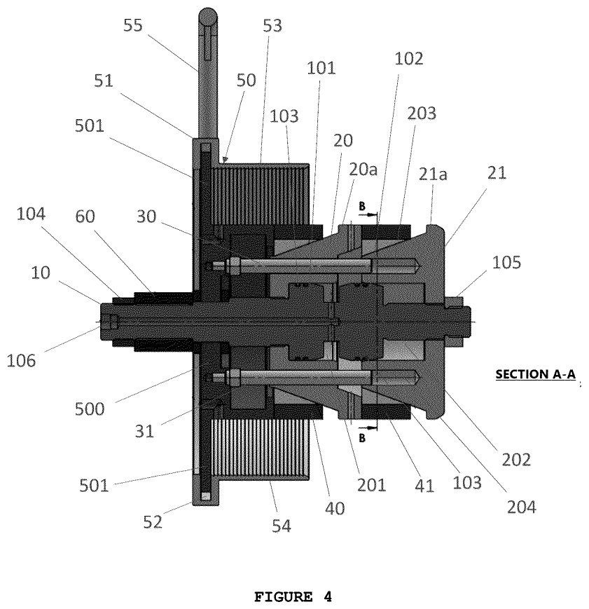

FIGS. 1 to 5 show, by way of example, a device for internal plugging of flexible pipelines according to an embodiment. Thus, the device for internal plugging of flexible pipelines 1 comprises: a central threaded rod 10; a first conical mandrel 20 and a second conical mandrel 21; an upper guide rod 30 and a lower guide rod 31; a first sealing member 40 and a second sealing member 41; a split outer clamp 50; and a central drive nut 60; wherein clamp 50 has a sealing portion 500 having a tab 501 that engages an upper recess 51 of clamp 50 and a lower recess 52 of clamp 50.

In one embodiment, the central threaded rod 10 passes through a through hole extending from the sealing portion 500 until it reaches the end of the second conical mandrel 21. The rod 10 further has a first shoulder 101 that fits into a hollow region 201 of the first mandrel 20 and a second shoulder 102 that fits into a hollow region 202 of the second mandrel 21. The rod 10 further has sealing o-rings 103 on the first and second shoulders 101, 102. In this way, the rod 10 is connected to the two conical mandrels 20, 21.

Furthermore, in one embodiment, the rod 10 further comprises a lock nut 104 fixedly secured in its front portion and a lock nut 105 secured in its rear portion, to keep the mandrels 20, 21 attached to the sealing portion 500 of the clamp 50. The rod 10 also has a central access 106 for sealing testing.

Furthermore, the central drive nut 60 is arranged in the front portion of the rod 10, being configured to actuate, or energize, the device when torque is applied to it by means of an appropriate torque tool, such as a torque wrench handled by the ROV, or others.

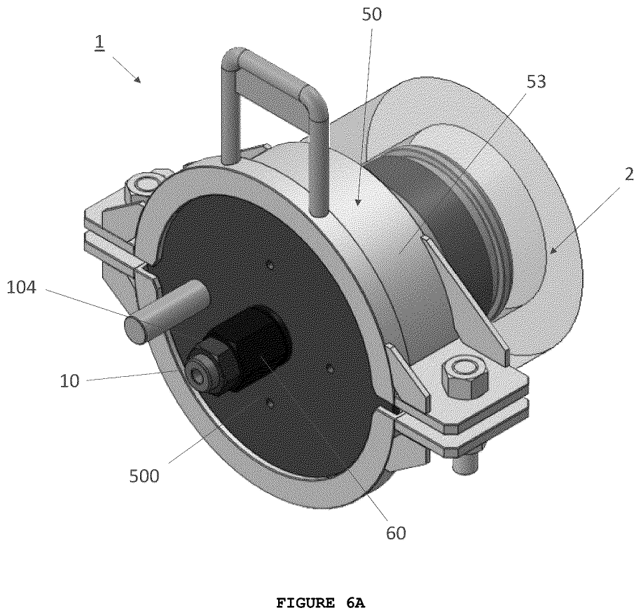

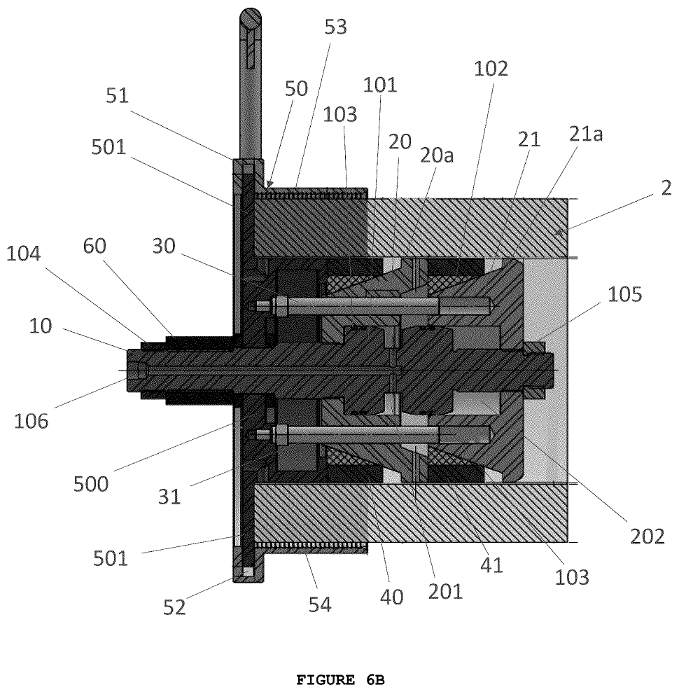

In one embodiment n, the first sealing element 40 is arranged around the first conical mandrel 20 and the second sealing element 41 is arranged around the second conical mandrel 21, so that when the rod 10 is actuated by means of the central drive nut 60, the mandrels 20, 21 retract, guided by means of the upper guide rod 30 and the lower guide rod 31, which are attached to the sealing portion 500, thus energizing the sealing elements 40, 41 against the inner wall of the flexible pipeline by means of shoulders 20a, 21a of the mandrels 20, 21, as shown in FIGS. 6A, 6B, 7A, 7B, 8A and 8B, which sequentially show the steps of the installation method of the device. The mandrels 20, 21 move through upper hollow portions 203 and lower hollow portions 204 where the upper guide rod 30 and the lower guide rod 31 are housed, respectively.

In embodiments, the sealing elements 40, 41 may be made of resistant and elastic polymeric materials, such as nylon or others.

Furthermore, in one embodiment, the clamp 50 further comprises an upper tab 53 and a lower tab 54 that extend rearwardly from recesses 51, 52 of the clamp 50 and surround at least a portion of the rod 10, forming an annular space therebetween. Thus, the upper tab 53 and lower tab 54 enclose at least a portion of a pipeline 2 to be sealed by the device, as shown in FIGS. 6A, 6B, 7A, 7B, 8A and 8B. By means of lateral fastening elements arranged on the tab 53, 54, such as casings and nuts, the split clamp 50 presses the cover or external surface of the pipeline 2 when it is closed to secure the assembly formed by the sealing portion 500 and the mandrels 20, 21 and, thus, seal the internal wall of the pipeline 2. The clamp 50 may further comprise a handle 55 for manipulation by ROV.

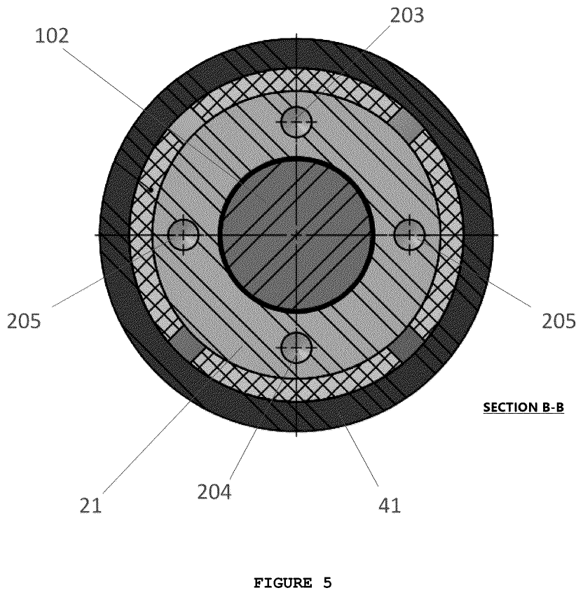

In embodiments, the device 1 may further include two lateral guide rods that are housed in lateral hollow portions 205 of the mandrels 20, 21, as shown in FIG. 5.

FIGS. 6A to 8B sequentially demonstrate a method of installing a device for internal plugging of flexible pipelines.

In particular, in a first step of the installation method, as shown in FIGS. 6A and 6B, the method comprises inserting the device 1 into an open end, which may be a cut end or not, of a subsea pipeline 2, by means of ROV, using the handle 55 adapted for such. In this first step of the method, after insertion, device 1 is in an unlocked and de-energized position, since the lateral fasteners of the clamp 50 and the central drive nut 60 have not yet been tightened or torqued.

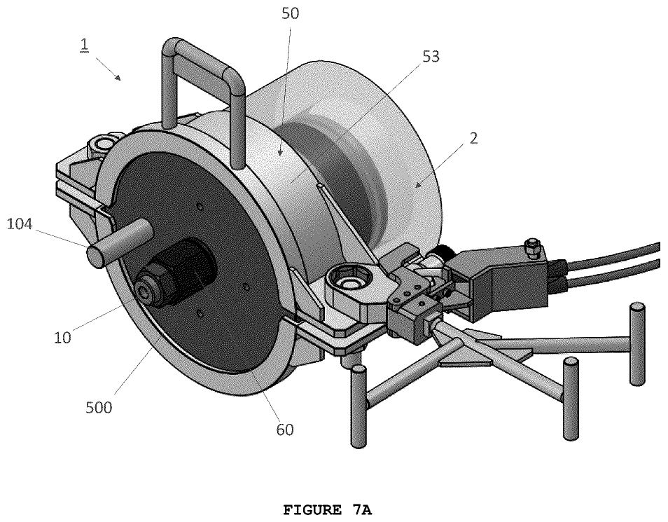

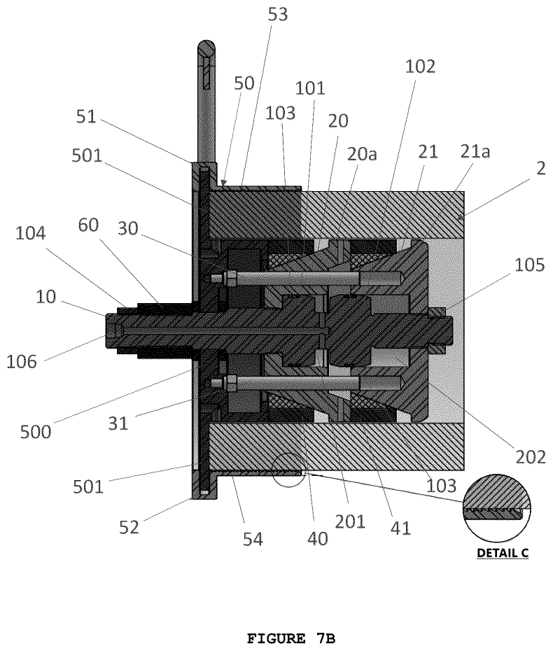

After inserting device 1 into pipeline 2, in a second step, the method comprises locking device 1 into pipeline 2 by tightening or torquing the lateral fasteners of the clamp 50 using a torque wrench adapted for use by ROV, as shown in FIGS. 7A and 7B. In this second step of the method, after being locked, that is, fixed to the external surface of the pipeline 2, the device 1 is in a locked and de-energized position, since the central drive nut 60 has not yet been tightened or torqued so that the sealing elements 40, 41 of the device 1 against the internal surface of the pipeline 2 can be energized. FIG. 7B shows in detail C how the internal surface of the upper 53 and lower 54 tabs of the clamp 50 are compressed against the external surface of the pipeline 2 in order to seal the region and prevent fluid from flowing down the sides of the device 1.

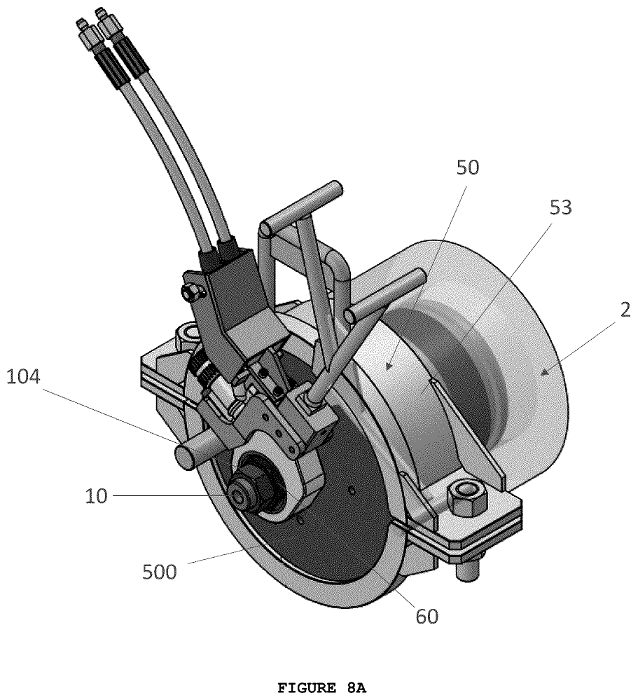

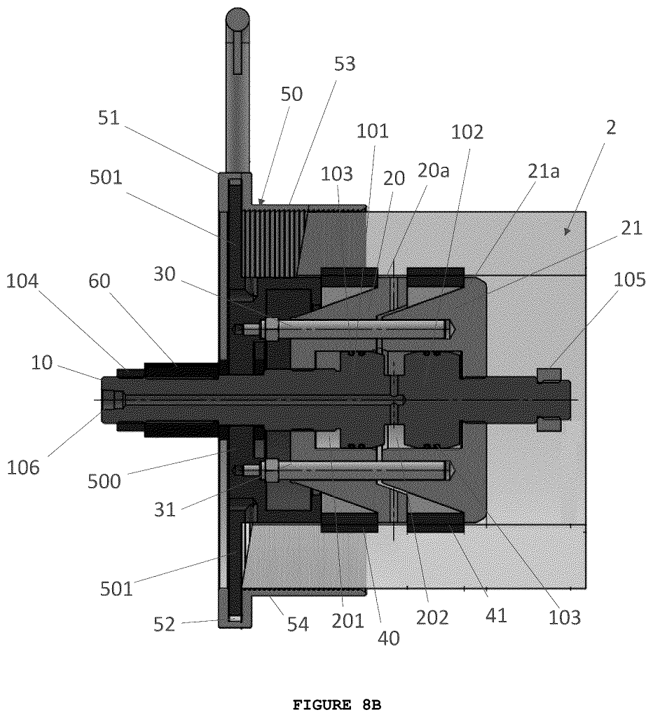

After the device 1 is locked against the external surface of the pipeline 2, the method further comprises actuating the rod 10 of the device 1 by tightening or torquing the central drive nut 60 using a torque wrench adapted for use by ROV, as shown in FIGS. 8A and 8B, so that the actuation of the rod 10 results in the retraction of the mandrels 20, 21, guided by the guide rods 30, 31, pressing the sealing elements 40, 41 against the internal surface of the pipeline 2 and, thus, energizing them. In this third step of the method, after actuating the rod 10, the device 1 is in a locked and energized position. Thus, the sealing of the internal surface of the pipeline 2 is performed, so that the fluid does not flow, blocked by the energized sealing elements 40, 41 and by the sealing portion 500.

It should be emphasized, therefore, that the device 1 and its installation method can promote low-pressure plugging in subsea flexible pipelines, using a double sealing system inside the pipeline, by means of the components and steps responsible for locking and energizing, as described above. Furthermore, the device and its associated installation method are combined with the clamp mechanism supporting the outer cover of the pipeline, and the device also has a port (or central access) for sealing testing, and a relief valve to maintain equalization between internal and external pressure during pipeline recovery. In this way, it is possible to recover a ruptured pipeline effectively and safely so that the fluid inside it does not escape to the external environment.

Those skilled in the art will appreciate the knowledge shown herein and will be able to reproduce various features and embodiments described herein and in other variants, covered by the scope of the attached claims.

1-13. (canceled)

14. A device for internal plugging of pipelines, comprising:
a central threaded rod having a first end and a second end;
a first conical mandrel and a second conical mandrel, the first conical mandrel having a recessed portion on its second end configured to receive a first end of the second conical mandrel, each first and second conical mandrel having a central aperture through which the central threaded rod passes therethrough;
an upper guide rod and a lower guide rod configured to advance through the first and second conical mandrels;
a first sealing element axially surrounding a portion of the first conical mandrel, and a second sealing element axially surrounding a portion of the second conical mandrel;
an external clamp having upper and lower tabs positioned around a first end of the device; and
a central drive nut positioned around a first end of the central threaded rod;
wherein the external clamp comprises a sealing portion having a tab extending into upper and lower recesses of the external clamp.

15. The device as claimed in 14, wherein the central threaded rod passes through a centrally-extending through hole of the device that extends from the sealing portion to a second end of the second conical mandrel.

16. The device as claimed in 14, wherein the central threaded rod further comprises a first shoulder configured to be positioned in a hollow region of the first conical mandrel, and a second shoulder configured to be positioned in a hollow region of the second conical mandrel.

17. The device as claimed in 14, wherein the central threaded rod further comprises a first fixing nut fixedly attached to the first end and a second fixing nut attached to the second end, to maintain the first and second conical mandrels connected to the sealing portion of the external clamp.

18. The device as claimed in 14, wherein the central threaded rod is configured to be actuated by means of the central drive nut, whereby actuating the central threaded rod causes the first and second conical mandrels to retract towards one another such that the first end of the second conical mandrel is moved into the recessed portion on the second end of the first conical mandrel, guided by the upper and lower guide rods, the upper and lower guide rods being attached to the sealing portion, thus energizing the sealing elements against an inner wall of the pipeline by means of projections positioned adjacent the second ends of the first and second conical mandrels.

19. The device as claimed in 18, wherein the first and second conical mandrels retract towards one another due to movement of the upper guide rod through a first hollow portion in the first and second conical mandrels, and movement of the lower guide rod through a second hollow portion in the first and second conical mandrels, the first and second hollow portions housing the upper and lower guide rods, respectively.

20. The device as claimed in claim 14, wherein the upper and lower tabs of the external clamp extend toward the second end of the device from the upper and lower recesses of the external clamp, the upper and lower tabs configured to enclose at least a portion of the central threaded rod and at least a portion of the pipeline to be sealed by the device.

21. The device as claimed in claim 14, wherein the external clamp further comprises lateral fastening elements configured to pass through the upper and lower tabs to press the upper and lower tabs together and secure the device to an outer surface of the pipeline.

22. The device as claimed in claim 14, wherein the external clamp further comprises a handle configured to be attached to and moved by a remotely operated vehicle (ROV).

23. The device as claimed in claim 14, herein the device further comprises two lateral guide rods that are housed in respective lateral hollow portions of the first and second conical mandrels.

24. A method of installing the device as claimed in claim 14 in and on a subsea pipeline, comprising:
inserting the device into an open end of a subsea pipeline;
locking the device into the subsea pipeline by pressing upper and lower tabs of the external claim towards one another; and
actuating the central threaded rod of the device by turning the central drive nut.

25. The method as claimed in claim 24, wherein the open end of the subsea pipeline is an open and cut end.
